(19) United States
(12) Patent Application Publication
(10) Pub. No.: US 2017/0330296 A1
(43) Pub. Date: Nov. 16, 2017

(54) Consumer Oriented Mobile Solution to Track Your Closing

(71) Applicants: Joseph C. Burke, Chicago, IL (US); Kevin J. Cooney, Chicago, IL (US)

(72) Inventors: Joseph C. Burke, Chicago, IL (US); Kevin J. Cooney, Chicago, IL (US)

(21) Appl. No.: 15/496,940

(22) Filed: Apr. 25, 2017

Related U.S. Application Data
(60) Provisional application No. 62/335,558, filed on May 12, 2016.

(51) Int. Cl. G06Q 50/16; G06Q 10/06; G06Q 40/00; G06Q 40/04; G06Q 40/06; G06Q 40/08; G06Q 30/06; G06Q 40/02

(52) U.S. Cl. CPC G06Q 50/167; G06Q 30/0605; G06Q 10/06316; G06Q 10/06313; G06Q 10/067; G06Q 40/025; G06Q 40/04; G06Q 40/06; G06Q 40/08; G06Q 40/10

(57) ABSTRACT

Track Your Closing is an invention that enables Home Sellers and Home Buyers to track the statuses of pre-closing steps in a real estate transaction and to learn of updates as they happen in real time. Track Your Closing enlists the Home Seller's and Home Buyer's respective attorneys to electronically input data as it becomes available. This data includes information collected for closing documents, statuses on pre-closing activities, and progress of transaction timelines. Home Sellers and Home Buyers make elections for the information, pre-closing activities, and transaction timelines for which they want notification. Track Your Closing then pushes this data and provides real time notifications to Home Buyers and Sellers of the status of any and all matters of which they elect to be kept aware. Track Your Closing's availability on mobile devices means information can be input and statuses and updates received at changing locations.

This nonprovisional application claims benefit to provisional application No. 62/335,558, filed May 12, 2016.

### BACKGROUND OF THE INVENTION

There is no known consumer oriented mobile application that informs Home Buyers and Home Sellers of the essential pre-closing steps that start from the moment the Home Buyer and Home Seller execute the sales contract. This invention is a solution for Home Buyers and Home Sellers that provides real time electronic notification on the status of events related to a real estate transaction that are tracked in one mobile application called Track Your Closing. Previous attempts to simplify the process relied on Gantt charts, updates from real estate agents, and usage fees. This was inefficient, cumbersome, and incompatible in states where attorneys, not real estate agents or brokers, hold the data crucial to a closing. This invention improves the pre-closing process by providing real time electronic alerts of attorneys' data input and service provider access. Furthermore, this invention provides selective information in a simultaneously timely and secure manner.

### BRIEF SUMMARY OF THE INVENTION

Track Your Closing provides a technology solution for the inefficient, cumbersome, and daunting process of executing all the essential pre-closing steps between a Home Buyer and a Home Seller that begin the moment they execute the sales contract.

Track Your Closing enlists attorneys to input data as it becomes available to their respective clients, whether a Home Seller or a Home Buyer. This data includes the information collected for closing documents, the status on pre-closing activities, and the progress of transaction timelines. Home Sellers and Home Buyers make elections for the information, pre-closing activities, and transaction timelines they want notifications. Track Your Closing then pushes this data and provides real time notifications to Home Buyers and Sellers of the status of any and all matters of which they elect to be kept aware.

The pre-closing process can often take several weeks and requires the efforts of multiple service providers who only have a few specific tasks to perform specific to a closing. Track Your Closing enables these other service providers to have limited access for the sole purpose of providing updates related to their assigned tasks. Regardless of the source of the information, the Home Seller and the Home Buyer still receive notification of the status through the same mobile application.

Track Your Closing is advantageous to all users. This invention solves problems not addressed by previous attempts to simplify the pre-closing process; specifically, Track Your Closing compiles all information in one spot and pushes updates to the users to have real time updates on the progress. Track Your Closing is consumer oriented, providing Home Sellers and Home Buyers selective information in a timely manner. This will reduce the time and expense for attorneys and real estate brokers to reply to consumer inquiries as they can be readily answered via the Track Your Closing mobile application. Decreased time spent by attorneys and real estate brokers equates to money saved by Home Buyers and Home Sellers.

Track Your Closing is an invention that also anticipates and preempts any unauthorized practice of law allegations that could otherwise emerge from pre-closing activities and status updates. Specifically, Track Your Closing controls which users can communicate or respond to inquiries from each consumer and by default necessitates that their respective legal counsel will remain the sole responder to legal inquiries. The invention is also timely as it is cognizant of recently enforced federal requirements concerning mortgage rules under the Dodd-Frank Act that require the protection of non-public personal information.

### BRIEF DESCRIPTION OF DRAWINGS

FIG. 1 lists the Contemplated Information that Track Your Closing is Capable of Tracking. FIG. 1 is a non-exhaustive list of all the Information on the Parties to the Transaction, Lender Specific Information, Checklists for Ongoing Items Subject to Multiple Steps and Timelines, and Closing Documents that can be a part of preparing for the closing on a property. Home Sellers and Home Buyers can elect to receive updates on the status of any and all of these items. As soon as information on any elected item is available, Home Sellers and Home Buyers receive real time notification of the status.

### DETAILED DESCRIPTION OF THE INVENTION

Track Your Closing is a mobile solution that provides a service that will be available with the same functionality in both portable and stationary format though computer, mobile, and tablet applications. The invention is oriented for consumer utilization wherein the entire platform is designed primarily with Consumers in mind. Consumers are able to select about which events they wish to receive notification irrespective of what internal events are occurring.

The services and interfaces will be tailored depending on the service user. The two types of users include those inputting data into the application, or “Information Controllers,” and those receiving updates specific to the data input, or “Consumers.” The type of user will also determine what information is necessary to use the service.

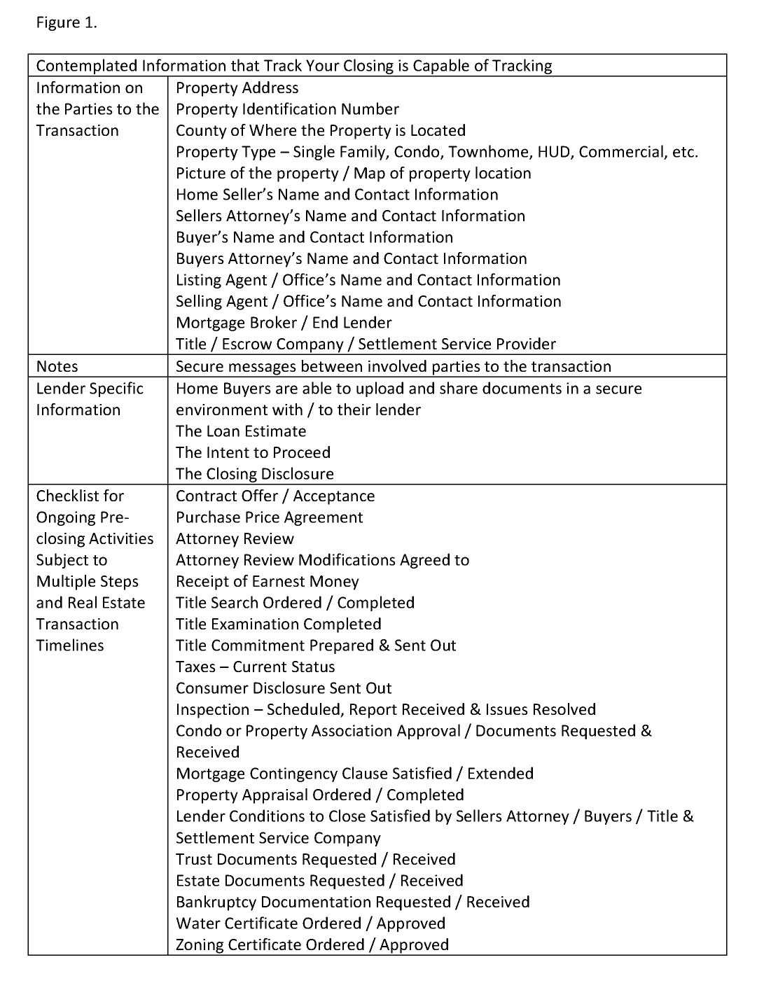

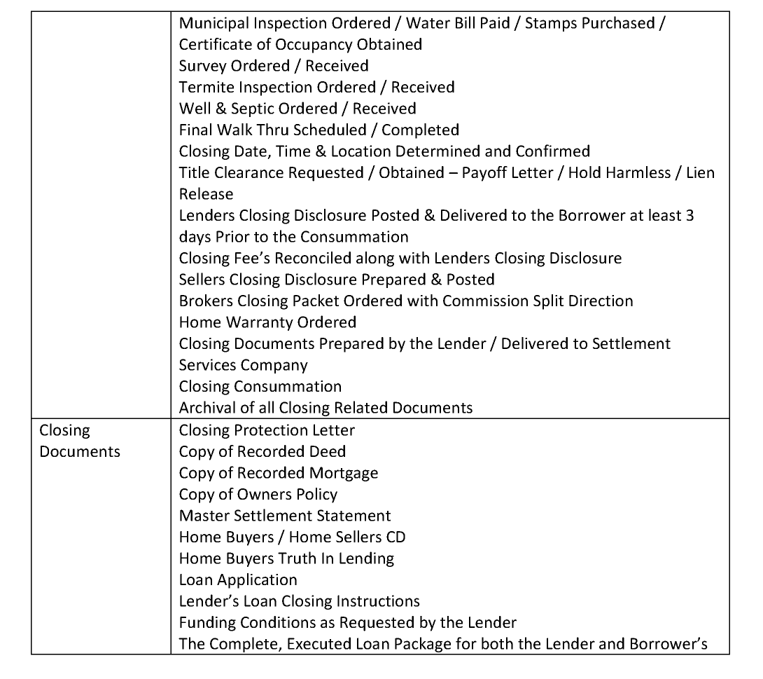

Track Your Closing informs Consumers of the essential pre-closing steps that start from the moment the Home Buyer and Home Seller execute the sales contract. Home Buyers and Home Sellers are the Consumers of this invention. Track Your Closing helps to organize the pre-closing process for Consumers in an otherwise cumbersome and tedious process. Track Your Closing simplifies tracking the progress on collecting the needed data for the items listed in FIG. 1, including the collection of information on the parties to the transaction, the disclosure of lender specific information, the status of transactions subject to multiple steps and timelines, and the completion and submission of closing documents.

Track Your Closing enables an Information Controller to input all incoming information (FIG. 1) that is generated and collected during the pre-closing process. Consumers are able to determine their own desired granular data level and tailor the incoming information to include only what the consumer wants to see. Knowing the status on the information obtained and information outstanding in the pre-closing process enables Consumers to accurately assess the progress of the pre-closing process in real time without having to spend time and money to contact the Information Controller. This invention takes all the pre-closing steps that start from the moment the Home Buyer and Home Seller execute the sales contract and provides updates on the progress of each in one mobile application.

In its initial form, when a Home Seller and Home Buyer execute the sales contract, the Track Your Closing system administrator, or “Closing Concierge,” will invite these Consumers to download the app and enable notifications regarding this property to be sent whenever there is incoming information. The Closing Concierge is conceived to have access to the selected information of which each Consumer wants notification and determines the privileges and access of each user. Specifically, the Closing Concierge will identify who are the Information Controllers and enable them to input and edit incoming information. The Closing Concierge will also identify who are the Consumers and enable them to view the incoming information.

The Track Your Closing invention enables the delivery of selected data to the Consumer in a timely manner. The data, referred to in FIG. 1 as “Contemplated Information that Track Your Closing is Capable of Tracking,” is known by those in the real estate business to be generally received or manufactured by three different sources in most states. These service providers include the Home Seller's Attorney, the Home Buyer's Attorney, and the mortgage lender. These are the “Information Controllers” and sources of data to whom the Closing Concierge will permit access to input and edit incoming information specific to a particular real estate transaction. Track Your Closing also enables the designation of Information Controllers to other service providers who will be permitted to utilize the invention with the use of a password for the limited purpose of inputting information regarding specific services they provide. All conveyance documents, including loan and closing documents, will be viewable in a secure platform that conforms to the requirements of Statement on Standards for Attestation Engagements (SSAE) 16.

It is contemplated that Information Controllers will post the data, and the data will then be pushed as a notification to the Consumers. If the Information Controller is a mortgage lender, the mortgage lender will post the data and the attorneys will then approve and push the data. When the anticipated data is not posted from a particular Information Controller, the Closing Concierge must seek out the data and post it. In this situation where the Consumer desired data is not pushed out by an Information Controller, it must instead be pulled out by the Closing Concierge. Whether the Consumer expected data is posted via pushing or pulling is irrelevant because either way, an update that the data has been provided is timely sent to all Consumers who signed up to receive a notification regarding same. Records are archived, and Consumers are given passwords to view records at a future date post-closing.

It is contemplated that Information Controllers will wholly replace the role of the Closing Concierge following the determination of the privileges and access of each user as Information Controllers become more acquainted with the invention and perform multiple closings with the assistance of the Track Your Closing invention. Specifically, it is conceived that the Information Controllers will be incentivized to “push and post” the data instead of needing the concierge to “pull and post” the data due to the efficiency and good will this will harbor with Consumers. This efficiency will decrease the time needed for an attorney to call a Consumer and decrease the Consumer's out of pocket costs for these calls. Instead, the attorney merely has to input the data, and the Consumer is immediately updated. This will decrease the attorney's fees and make the attorney more appealing to other potential clients down the road. Track Your Closing gives attorneys can have access to as many real estate transactions that they have pending for purposes of posting data.

Track Your Closing also has a click thru feature with attorney pre-approved explanations for each conveyance related document and event to which Consumers have unlimited access. It is expected that after an orientation period, the vast majority of transaction data will be pushed and posted by the Information Controllers to minimize any expense or delay in having the Closing Concierge involved as a middle man.

This invention offers not only timely notice to its Consumers but also offers a mechanism to keep data safe and secure. Under existing systems that give access to a mortgage lender, the mortgage lender might disclose that a mortgage loan has been approved for purposes of informing the parties that the real estate contract provision concerning financing has been complied with. However, starting Oct. 3, 2015, the Dodd-Frank Act introduced federal regulations that require the protection of non-public personal information (NPI). Track Your Closing efficiently conforms to this requirement in that the disclosure delivery mechanism will no longer be handled by mortgage lenders but instead will be delegated to others deemed more secure and reliable—the Home Buyer and Home Seller's respective attorneys. The invention effectively precludes lender disclosure of information that may be construed as NPI and is meant to be kept confidential by keeping the attorney as the gatekeeper of the information input into the app.

The invention also limits the role of third party escrow entities; third party escrow entities are not the data gatekeepers for this invention as they are not customarily the gatekeepers of the pre-closing data and real estate transaction status in many states. Brokers have minimal to no involvement in the management or closing of the transaction and in some states are not qualified to do so. Instead, some states require attorneys to provide this information to Consumers, even if brokers or escrow entities have been tasked with that responsibility. This invention contemplates attorneys as the data gatekeepers who have the ability to block or release certain information from other parties to be seen by their clients. This invention does not rely on each real estate agent to independently create a list of tasks to be performed and provide updates to Consumers. Instead, real estate agents have no role in the invention or any responsibility to providing pre-closing status updates to the Consumers, and attorneys monitor the transactions.

These services will be provided at a cost to be determined by market forces and demand. Access by any user will be password protected. In its current embodiment, there is no anticipated usage fee to Consumers or Information Controllers for the invention. It is anticipated that Consumers could use Track Your Closing to obtain quotes and other ancillary closing services and products such as Homeowners insurance. This referral service will serve as advertisement and provide the requisite funding for the application to keep it free for Home Sellers and Buyers but still be a profitable business venture.

It will be appreciated that variations of the above-disclosed and other features and functions, or alternatives thereof, may be desirable and combined into many other different systems or applications. Also, that various presently unforeseen or unanticipated alternatives, modifications, variations or improvements therein may be subsequently made by those skilled in the art which are also intended to be encompassed by the above description. Where methods and steps described above indicate certain events occurring in certain order, those of ordinary skill in the art having the benefit of this specification would recognize that the ordering of certain steps may be modified to be performed in different orders and/or in concurrently, and that such modifications are in accordance with the variations of the invention. Thus, the methods illustrated are not intended to be limited to a particular sequential order, particularly in instances in which certain steps may or may not be performed or may be performed simultaneously. In addition, embodiments of services, both basic and premium, are intended to exemplify alternatives, modifications, and equivalents that may fall within the scope of this specification.

1. A method of tracking real time updates and statuses of pre-closing steps in a real estate transaction between a Home Seller and a Home Buyer, said method comprising the steps of:
the Home Seller and the Home Buyer executing a sales contract for a property;
software electronically collecting and storing manually entered information about the status of the pre-closing steps and pushing notifications of the status of said pre-closing steps to the Home Seller and the Home Buyer;
a Closing Concierge inviting the Home Seller to access the software and enabling said Home Seller to receive real time notifications of the status of the pre-closing steps through the software;
the Closing Concierge inviting the Home Buyer to access the software and enabling said Home Buyer to receive real time notifications of the status of the pre-closing steps through the software;
the Closing Concierge inviting Information Controllers to access the software;
the Information Controllers updating and editing the status of pre-closing steps through the software; and
the Home Buyer and the Home Seller accessing in real time the updates and statuses of said pre-closing steps through the software.

2. The method of claim 1 wherein the step of the Home Seller and the Home Buyer executing a sales contract for a property further comprises the step of the Home Seller retaining a Home Seller's attorney.

3. The method of claim 1 wherein the step of the Home Seller and the Home Buyer executing a sales contract for a property further comprises the steps of the Home Buyer retaining a Home Buyer's attorney and retaining a mortgage lender.

4. The method of claim 1 wherein the pre-closing steps to which the Home Seller and the Home Buyer have access comprise information and conveyance documents necessary to complete the real estate transaction, disclosure of the mortgage lender's identity, statuses of pre-closing steps subject to multiple steps and timelines, and completion and submission of documents required for closing.

5. The method of claim 4 further comprising the step of the Home Seller requesting explanations to the information and conveyance documents necessary to complete the real estate transaction to which only the Home Seller's attorney can respond.

6. The method of claim 4 further comprising the step of the Home Buyer requesting explanations to the information and conveyance documents necessary to complete the real estate transaction to which only the Home Buyer's attorney can respond.

7. The method of claim 4 further comprising the step of the Home Seller choosing which of the pre-closing steps said Home Seller wants notification through the software.

8. The method of claim 4 further comprising the step of the Home Buyer choosing which of the pre-closing steps said Home Buyer wants notification through the software.

9. The method of claim 1 wherein the step of the Closing Concierge giving Information Controllers access to the software further comprises the step of enabling the Information Controllers to update and edit the statuses of pre-closing steps through the software.

10. The method of claim 1 wherein the Information Controllers comprise the Home Seller's attorney, the Home Buyer's attorney, the mortgage lender, and service providers.

11. The method of claim 10 further comprising the Home Boyer's attorney approving updates and edits of statuses of the pre-closing steps from the mortgages lender and service provider and pushing notifications of said status to the Home Seller and the Home Buyer through the software.

12. The method of claim 10 wherein the service providers update and edit the status of pre-closing steps through the software for the limited purpose of inputting and editing the status of pre-closing steps related specifically to the service or services said service providers provide.

13. The method of claim 10 wherein the service providers advertise and disclose predicted costs for the service or services said service providers provide to Home Sellers and Home Buyers through the software.

14. The method of claim 1 wherein said software is available on portable and stationary devices through computer, mobile, and tablet applications.

15. The method of claim 1 further comprising the step of the Home Seller and the Home Buyer accessing the status of any pre-closing step in real time without expending time, money, or resources to contact Information Controllers.

16. The method of claim 1 further comprising the step where the Information Controllers can have access to the pre-closing status of more than one sales contract of a property for a real estate transaction between a Home Seller and a Home Buyer through the software.

17. The method of claim 4 wherein the Home Seller and the Home Buyer can access legal explanations for conveyance documents necessary to complete the real estate transaction.

18. The method of claim 4 wherein said conveyance documents are accessible to view in a secure platform.

19. The method of claim 1 further comprising the step of the Home Seller and the Home Buyer accessing and viewing information and conveyance documents post-closing of the real estate transaction.
